(19) United States
(12) Patent Application Publication
(10) Pub. No.: US 2017/0088132 A1
(43) Pub. Date: Mar. 30, 2017

(54) Method for detecting interferences in a crop collection system

(71) Applicant: CLAAS E-SYSTEMS KGAA MBH & CO KG, GUETERSLOH (DE)

(72) Inventors: Burkhard Sagemueller, GUETERSLOH (DE); BORIS KETTELHOIT, GUETERSLOH (DE); THILO KRAUSE, GLINDE (DE); CHRISTIAN LAING, HARSEWINKEL (DE); JESPER VILANDER, FREDENSBORG (DK); BENJAMIN HEYNE, OSNABRUECK (DE); MORTEN RUFUS BLAS, KONGENS LYNGBY (DK); KASPER LUNDBERG LYKKEGAARD, KOBENHAVN S (DK); JOHANN INGIBERGSSON, COPENHAGEN N.V. (DK); TOMMY ERTBOLLE MADSEN, VIRUM (DK)

(21) Appl. No.: 15/278,326

(22) Filed: Sep. 28, 2016

(30) Foreign Application Priority Data
Sep. 30, 2015 (DE) 102015116574.0

(51) Int. Cl. B60W 30/09; A01B 76/00; H04N 5/33; B60W 50/14; G06K 9/00; A01B 69/04; A01D 41/127

(52) U.S. Cl. CPC B60W 30/09; A01B 69/008; A01B 76/00; A01D 41/1278; B60W 50/14; G06K 9/00805; H04N 5/332; B60W 2050/143; B60W 2050/146

(57) ABSTRACT

A self-propelled agricultural working machine has at least one working unit such as a ground drive, a driver assistance system for generating control actions within the working machine, and a sensor system for generating pieces of environmental information. The driver assistance system generates the control actions on the basis of the pieces of environmental information. The driver assistance system assigns an urgency level to each of the pieces of environmental information and generates the control actions on the basis of the pieces of environmental information and the particular assigned urgency levels.

### CROSS-REFERENCE TO A RELATED APPLICATION

The invention described and claimed hereinbelow is also described in German Patent Application DE 10 2015 118 574.0, filed on Sep. 30, 2015. The German Patent Application, the subject matter of which is incorporated herein by reference, provides the basis for a claim of priority of invention under 35 U.S.C. 119(a)-(d).

### BACKGROUND OF THE INVENTION

The invention relates to a self-propelled agricultural working machine. Self-propelled agricultural working machines are known. The phrase “self-propelled agricultural working machine” is intended to be broadly interpreted herein to include not only harvesting machines such as combine harvesters and forage harvesters, but also towing machines such as tractors or the like. As the dimensions of known agricultural working machines continue to increase, machine operators are faced with a growing challenge of reacting to objects in the environment of the working machine in a way that is correct for the particular situation. Such objects, which can be persons, animals, stationary or moving objects in the environment of the working machine, are referred to very broadly in the present case as “peripheral objects.”

WO 2015/000839 A1 discloses a tractor that includes a sensor-supported device for avoiding collisions with such peripheral objects. Specifically, the working machine disclosed in WO 2015/000839 is equipped with a driver assistance system which generates control actions within the working machine on the basis of the signals from a sensor system. Such a control action is, for example, a steering action, by means of which the driver assistance system initiates an evasive maneuver around a detected peripheral object.

The sensor arrangement of the known working machine (WO 2015/000839 A1) includes two 3D cameras which detect the geometric extension of the load to be drawn by the tractor and also to detect the environment of the working machine in the direction of travel. In this context, it also has become known to replace the use of 3D cameras with laser range finders or time-of-flight cameras.

One challenge faced by the known agricultural working machine (WO 2015/000839 A1) is that of achieving high operating efficiency in combination with high operational reliability. The reason for this is that high operational reliability can be achieved by use of a high sensitivity of the sensor system. A high sensitivity of the sensor system, however, generally results in a relatively high error detection rate and, therefore, in work interruptions which are frequently unnecessary and, in the end, results in reduced operating efficiency. Reducing the sensitivity of the sensor system, however, results in poorer reliability of the sensor system, which, in turn, adversely affects the operational reliability.

A further disadvantage of the known agricultural working machine (WO 2015/000839 A1) resides in the fact that such potential collisions, which very likely do not even occur, also result in the working machine coming to a standstill; this of course substantially reduces the working machine's operating efficiency.

### SUMMARY OF THE INVENTION

The present invention overcomes the shortcomings of known arts, such as those mentioned above.

The present invention provides an improved self-propelled agricultural working machine in which both its operational reliability and its operating efficiency are increased.

In an embodiment, the invention presents a self-propelled agricultural working machine with working unit such as a ground drive, a driver assistance system for generating control actions within the working machine, a sensor system for generating pieces of environmental information used by the driver assistance system to generate the control actions; wherein the driver assistance system assigns an urgency level to each piece of environmental information and generates the control actions on the basis of the pieces of environmental information and the particular assigned urgency levels.

Control actions can be generated in a way which is oriented toward high operational reliability and, simultaneously, high operating efficiency by assigning an urgency level to every piece of environmental information. On the basis of the urgency level, the driver assistance system decides which control action should be carried out and at which level of intensity.

The driver assistance system assigns an urgency level to each piece of information and generates the control actions on the basis of the environmental information and the particular assigned urgency levels. As a result of the introduction of urgency levels, the reaction to a less urgent piece of information, such as, for example, the detection of a mound of dirt which does not pose a risk to the harvesting operation, can be initially withheld. An urgent piece of information, for example, the detection of a person in the immediate vicinity of the front attachment of a combine harvester, can, in turn, be handled by the driver assistance system with highest priority by way of the driver assistance system generating the corresponding control action. For example, this particular corresponding control action might include braking the working machine immediately and with high intensity, i.e., using high braking power.

That is, the inventive driver assistance system may implement control actions based on the environmental information with higher or lower priority than other pending control actions depending on the particular urgency level. The higher-priority implementation of the control actions can be achieved, using software, using a mechanism designed as a type of interrupt.

In an embodiment, a particularly simple determination of the control actions results since at least one urgency level is fixedly assigned to a predetermined control action. Preferably, variants for establishing the urgency level of the particular piece of environmental information are preferably included. For example, the invention provides for a weighting of influential factors such as the ground speed and the object category.

Environmental information regarding a peripheral object can be generated in a differentiated manner by way of a piece of environmental information comprising sensor information gathered by two different sensors. In this case, “different” is considered to mean that the sensors gather their particular sensor information on the basis of different physical properties of the peripheral object. As a result, it is possible, for example, to detect a peripheral object using a standard light camera and a thermal imaging camera. Whereas the standard light camera provides information regarding the shape, coloration, or the like, of the peripheral object, the temperature of the peripheral object is ascertained using the thermal imaging camera. On the basis of this sensor information, the driver assistance system generates a piece of environmental information which includes, for example, detailed information on whether the peripheral object should be assigned to the object category “living” or to the object category “not living.” On the basis thereof, in turn, the driver assistance system can determine how to react to the detected peripheral object.

Very generally, the sensor system preferably includes at least one further sensor which detects a further piece of sensor information on the basis of a further physical property of the peripheral object. On that basis, the driver assistance system generates a piece of environmental information on the peripheral object on the basis of the first piece of sensor information and the further piece of sensor information. In the simplest case, the piece of environmental information can result from the combination of the pieces of sensor information gathered by the sensors. It also is conceivable, however, that the pieces of sensor information are conditioned in this case, in particular, that derived variables such as the geometric outline, the temperature distribution, the position and/or movement of a peripheral object are ascertained from the pieces of sensor information and are assigned to the piece of environmental information.

As explained above, the detection of the peripheral object using two differently functioning sensors allows for a differentiated reaction to the peripheral object depending on its object category or on its object type, which will be explained. As a result, the operational reliability as well as the operating efficiency are increased.

A further increase in the operating efficiency is achieved by way of the sensors having a shared detection zone and/or by way of the two sensors simultaneously generating pieces of sensor information for the piece of environmental information related to the peripheral object. As a result, it is readily possible for the pieces of sensor information gathered by all the sensors in the sensor system to be present simultaneously, which further increases the speed of the evaluation and, therefore, the operating efficiency. In principle, it also is conceivable, however, that the pieces of sensor information for the piece of environmental information related to the peripheral object be present sequentially, for example, because the individual detection zones of the sensors do not overlap or only slightly overlap.

Further preferably, the first sensor in the sensor system is based on the reflection of radiation, in particular, electromagnetic radiation, as is the case with a standard light camera, wherein the further sensor in the sensor system operates on the basis of the emission of radiation, in particular, electromagnetic radiation, which is the case with a thermal imaging camera. The advantage of the combination of two such sensors has already been explained further above.

In an embodiment, the peripheral objects are subdivided into different object categories and into different object types, which facilitates a differentiated generation of the control actions by the driver assistance system. The object type in this case and preferably is a subcategory of the particular object category. Preferably, the driver assistance system generates the particular control action depending on the object category and/or the object type.

Different variants of the control actions generated by the driver assistance system on the basis of the pieces of environmental information are conceivable. For example, the invention that these actions may include a warning action, a braking action, a steering action or an action to adjust a working unit. The driver assistance system decides which of these actions to carry out and at what intensity on the basis of predetermined criteria.

### BRIEF DESCRIPTION OF THE DRAWINGS

Further features and advantages of the invention will become apparent from the description of embodiments that follows, with reference to the attached figures, wherein:

FIG. 1 shows a front view of a self-propelled agricultural working machine, constructed according to the invention,

FIG. 2 shows the working machine of FIG. 1 in a first operating situation,

FIG. 3 shows the working machine of FIG. 1 in a second operating situation; and

FIG. 4 is a schematic representation of a sensor-based generation of control actions by the driver assistance system of the self-propelled agricultural working machine according to FIG. 1.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

The solution according to the invention can be applied to a wide range of self-propelled agricultural working machines, including without limitation combine harvesters, forage harvesters and towing machines such as tractors, or the like. In an embodiment, the working machine 1 is a combine harvester which is equipped with a front attachment 2 in a way which is customary per se. All comments made with respect to a combine harvester apply similarly for all other types of working machines.

The working machine 1 according to the invention is equipped with at least one working unit. 3-8. A working machine 1 designed as a combine harvester preferably includes a ground drive 3, a header 4, a threshing unit 5, a separating device 6, a cleaning device 7 and a spreading device 8. as the working units in the embodiment shown.

The working machine 1 is further equipped with a driver assistance system 9 for generating control actions within the working machine 1. The control actions can relate to the display of information for the user and for the control and parametrization of the working units, 3-8.

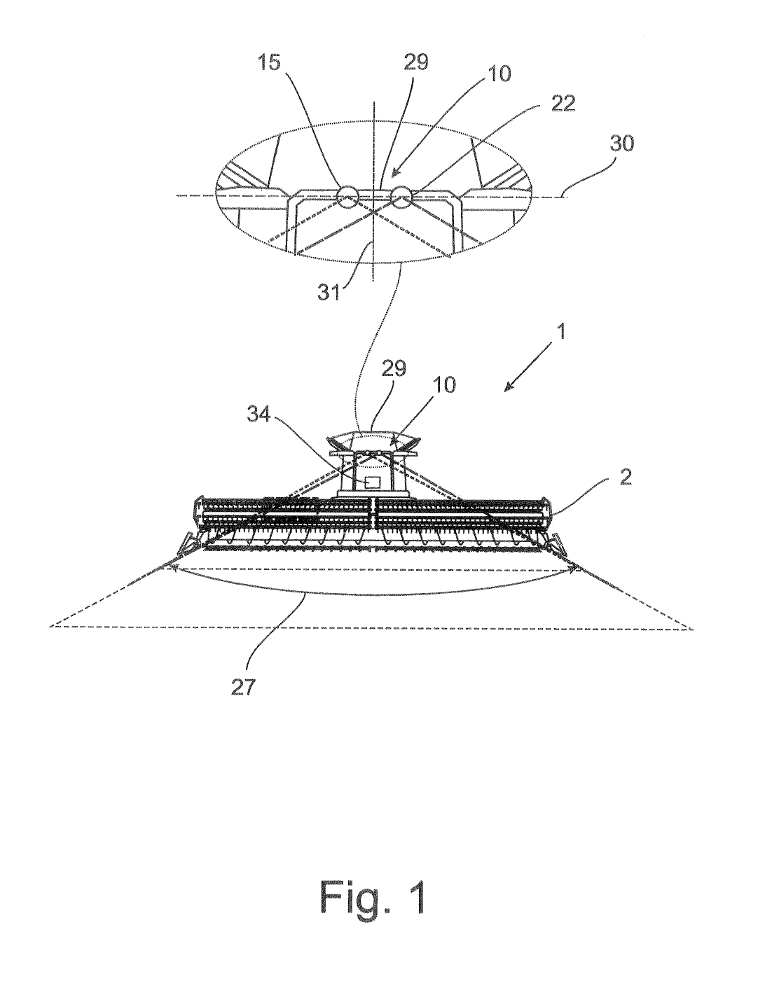

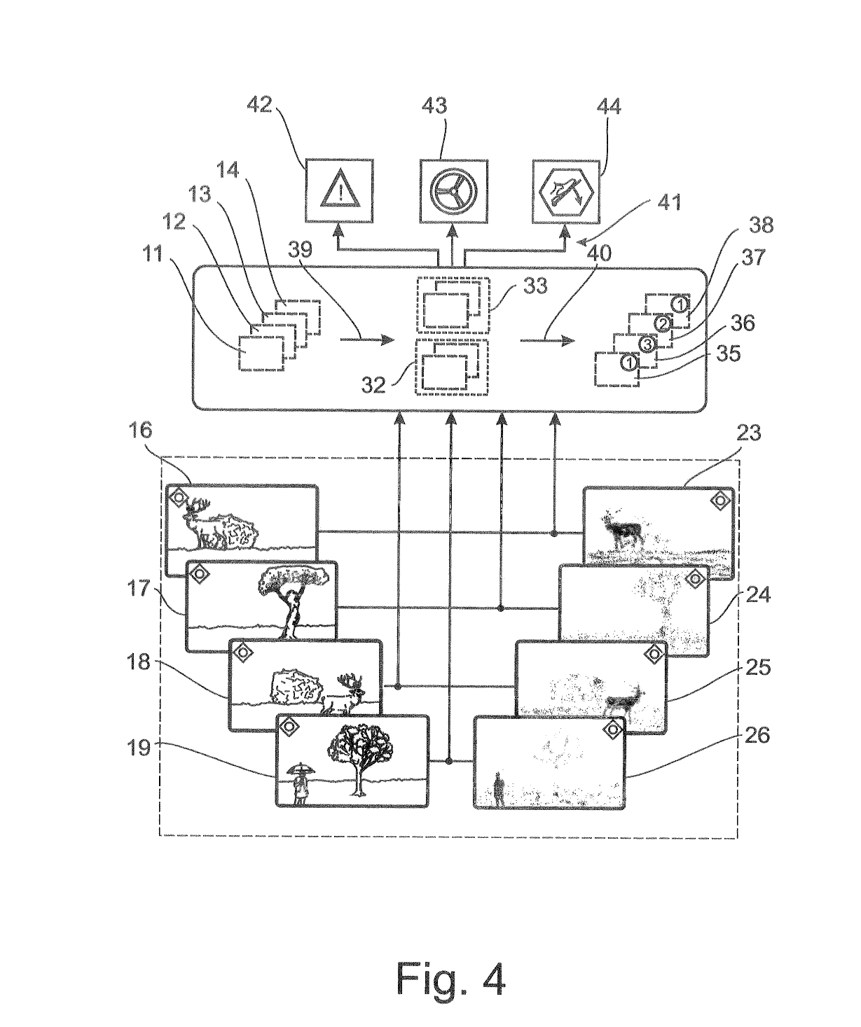

It is clear from the representations according to FIGS. 1 to 3 that a sensor system 10 for generating pieces of environmental information 11-14 is provided, wherein the driver assistance system 9 generates the control actions in each case based on the pieces of environmental information 11-14 (FIG. 4). For this purpose, the sensor system 10 preferably includes a first sensor 15 which generates a first piece of sensor information 16-19 based on a first physical property of a peripheral object 20, 21 in the environment of the working machine 1. The first sensor 15 is preferably a standard light camera, and so the first piece of sensor information 16-19 is a corresponding image of the peripheral object 20, 21 in the visible spectrum.

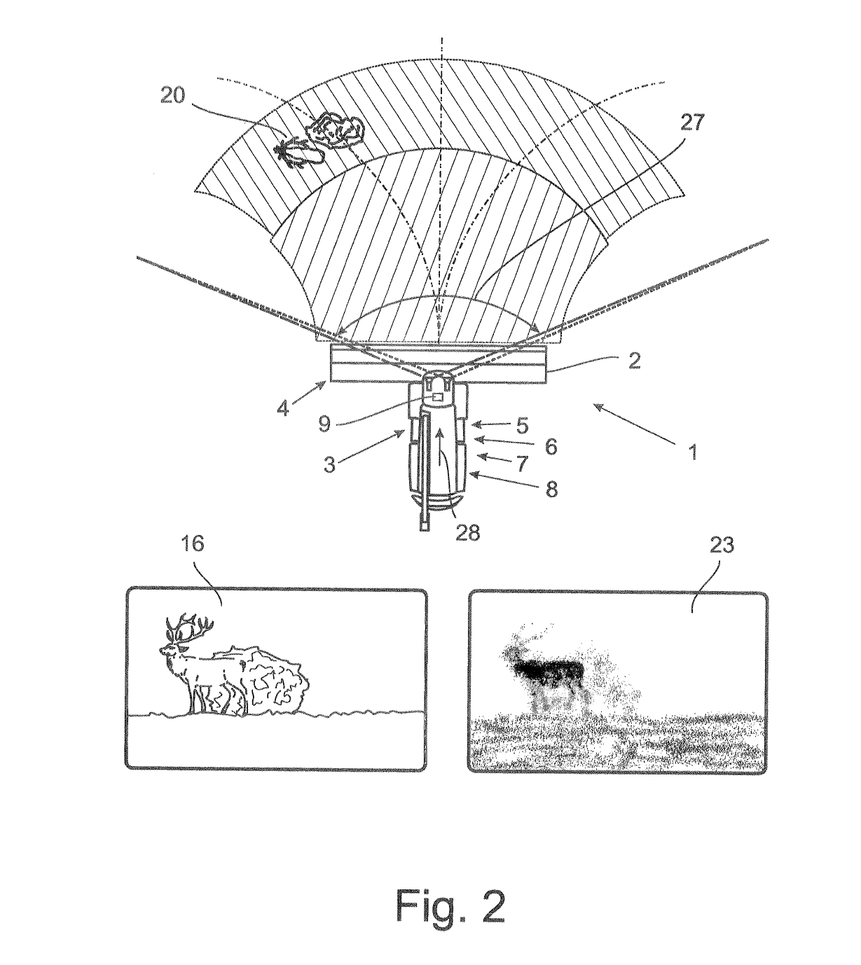

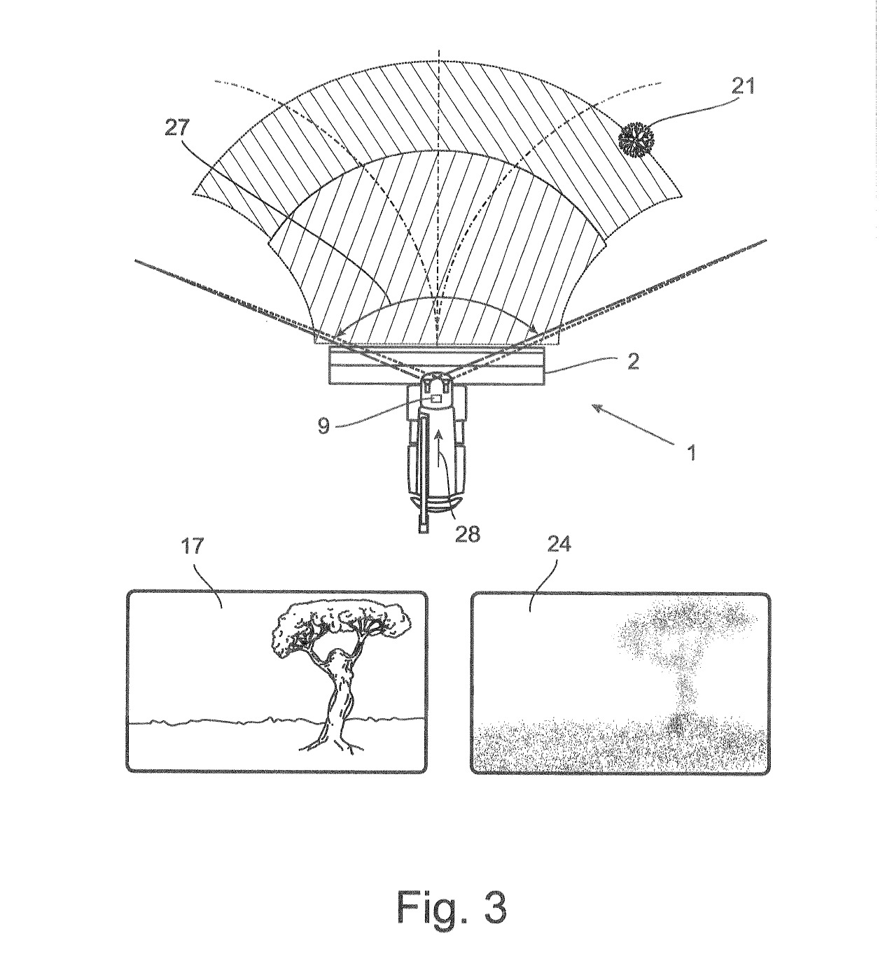

The peripheral object 20, 21 can be any type of object in the environment of the working machine 1, which can be distinguished from the rest of the environment of the working machine 1 in any way. Typical peripheral objects are animals 20 (FIG. 2) or obstacles such as trees 21 (FIG. 3), rocks, or the like.

Further preferably, the sensor system 10 includes at least one further sensor 22 which gathers a further piece of sensor information 23-26 based on a further physical property of the peripheral object 20, 21. In this case and preferably, the sensor system 10 includes exactly one further sensor 22. All the comments presented in this regard apply similarly for all of the further, additionally provided sensors.

The further sensor 22 in the exemplary embodiment, which is represented and insofar preferred, is a thermal imaging sensor, which also will be explained. The thermal imaging sensor generates an image of the peripheral object 20, 21 in the invisible infrared spectrum.

Preferably, the driver assistance system 9 generates, on the basis of the first piece of sensor information 16-19 and the further piece of sensor information 23-26, a resultant piece of environmental information 11-14 regarding one and the same peripheral object 20, 21. The information content of the piece of environmental information 11-14 is particularly high, due to the combination of the first piece of sensor information and the further piece of sensor information, since the two sensors 15, 22 operate on the basis of different physical properties of the peripheral object 20, 21 and therefore deliver complementary information regarding the peripheral object 20, 21.

The first sensor 15 and the further sensor 22 are preferably designed and arranged in such a way that the sensors 15, 22 have a shared detection zone 27 (FIGS. 1 and 3). This means that the detection zones of the sensors 15, 22 overlap at least to the extent that a shared detection zone 27 results. The individual detection zones of the sensors 15, 22, therefore, do not need to be identical to one another.

Furthermore, it is preferable that the first sensor 15 and the further sensor 22 simultaneously Generate pieces of sensor information 16-19, 23-26 for the piece of environmental information 11-14 regarding one and the same peripheral object 20, 21. Given that the pieces of sensor information 16-19, 23-26 from the two sensors 15, 22 are provided simultaneously, the pieces of environmental information 11-14 can be generated with a high refresh rate, which further increases the operational reliability.

Preferably, the shared detection zone 27 of the sensors 15, 22 is located in the environment of the working machine 1, preferably ahead of the working machine 1 with respect to the direction of travel 28, as represented in the drawing.

It is clear from the detailed representation according to FIG. 1 that the sensors 15, 22 (two in this case), are mounted on the operator's cab 29 of the working machine 1. Very generally, it is preferable that the sensors 15, 22 are situated next to one another, in particular, on a horizontally extending, imagined line 30. In a particularly preferred embodiment, the sensors 15, 22 are situated in symmetry with one another relative to a center plane 31 extending vertically along the working machine 1, which allows for a correspondingly symmetrical extension of the shared detection zone 27.

As mentioned above, the two sensors 15, 22 operate on the basis of different physical properties of the peripheral object 20, 21, and so a particularly high information content results for the particular resultant piece of environmental information 11-14.

The first sensor 15 in the sensor system 10 generates the first piece of sensor information 16-19, on the basis of the reflection of electromagnetic radiation, in particular, of laser radiation or of visible luminous radiation, by the peripheral object 20, 21. Therefore, the first sensor 15 is preferably a laser sensor, such as a 3D laser sensor, a laser scanner or the like. In an embodiment, the first sensor 15 is designed as a standard light camera, however, in particular, as a 3D camera or as a time-of-flight camera (TOF camera). It also is conceivable that the first sensor 15 is designed as a radar sensor, which is a 3D radar sensor. Finally, in a particularly cost-effective embodiment, the first sensor 15 is designed as an ultrasonic sensor.

Depending on the embodiment of the first sensor 15, the first piece of sensor information 16-19 can provide entirely different information about the peripheral object 20, 21. Depending on the sensor 15, the first piece of sensor information 16-19 can be a shape and/or a coloration and/or a speed and/or motion characteristic of the peripheral object 20, 21. It also is conceivable that the first piece of sensor information 16-19 is only the direction of motion of the peripheral object 20, 21.

The further sensor 22 of the sensor system 10 generates the further sensor information 23-26 preferably on the basis of the emission of electromagnetic radiation, e.g., infrared radiation, by the peripheral object 20, 21. Therefore, the further piece of sensor information 23-26 is preferably a temperature or a temperature spectrum of the peripheral object 20, 21.

The particular piece of environmental information 11-14 includes one or more descriptive parameters for the relevant peripheral object 20, 21, which make it possible to assign the peripheral object 20, 21 to predefined categories or types of peripheral objects.

Therefore, it is first provided that the driver assistance system 9 assigns an object category 32, 33 from the object categories “living” and “not living” to the peripheral object 20, 21 on the basis of the pieces of environmental information 11-14. In the case of the first piece of sensor information 16 represented on the left in FIG. 2, the peripheral object 20 shown there could be, in principle, a small tree or the like. However, the further piece of sensor information 23, represented on the right in FIG. 2, shows that it is an animal, according to the ascertained temperature of the peripheral object 20 and, with respect to the shape ascertained according to the first piece of sensor information 16, it is a deer. With the aid of the solution according to the invention, it is therefore possible to not only determine the object categories “living” and “not living”, but also the particular type of object, such as “animal”, “person”, “rigid object” or “vehicle with engine.”

In the situation shown in FIG. 3, however, the first piece of sensor information 17, which is represented on the left in FIG. 3, could provide information that the peripheral object 21 is a person. However, the further piece of sensor information 24, which is represented on the right in FIG. 3, shows that the peripheral object 21 should be assigned to the object category “not living.” On the basis of these two pieces of sensor information 17, 24, the driver assistance system 9 generates the piece of environmental information that the peripheral object 21 is a tree.

A corresponding instruction for assigning the object category and/or the object type to the peripheral object 20, 21 is stored in a memory of the driver assistance system 9. In this case and preferably, the driver assistance system 9 makes the assignment of the object category and/or the object type dependent on whether a first necessary condition relating to the first piece of sensor information 16-19, in particular a predetermined shape of the peripheral object 20, 21, and a second necessary condition relating to the further piece of sensor information 23-26, in particular a predetermined temperature range, have been met. In this case, simple rules can be established for the object categories and object types, which provide for good coverage of the anticipated peripheral objects 20, 21 and which can be processed in an automated manner, in particular.

Different advantageous variants of the sequence in which the different pieces of sensor information 16-19, 23-26 are evaluated is conceivable. In this case and preferably, the driver assistance system 9 monitors, in a monitoring step, the pieces of sensor information 23-26 from the further sensor 22 to determine whether a peripheral object 20, 21 is even present in the shared detection zone 27. For the case in which a peripheral object 20, 21 has been detected, the driver assistance system 9 determines, in an evaluation step, the object category 32, 33 and/or the object type of the peripheral object 20, 21 on the basis of the pieces of sensor information 16-19 from the first sensor 15 and the pieces of sensor information 23-26 from the further sensor 22.

After the object category 32, 33 and/or the object type of the peripheral object 20, 21 have been determined, the driver assistance system 9 can generate the control actions depending on precisely these pieces of information. In this case, the pieces of environmental information preferably include not only the object category 32, 33 and the object type of the peripheral object 20, 21, but also position information or movement information relative to the working machine 1, and so these additional pieces of information also can be taken into account in the generation of the control actions.

As explained above, the different mode of operation of the sensors 15, 22 results in a particularly high information content of the pieces of environmental information. In the sense of a high quality of the pieces of sensor information 16-19, 23-26, it can be advantageously provided that the driver assistance system 9 takes the pieces of sensor information 16-19, 23-26 from the sensors 15, 22 in the sensor system 10 into account differently depending on the illumination of the shared detection zone 27. For example, it can be provided that both sensors 15, 22 are taken into account during the day, whereas, at night, the further sensor 22, which is preferably designed as a thermal imaging sensor, is utilized first of all.

The control actions generated by the driver assistance system 9 on the basis of the pieces of environmental information 11-14 can differ greatly depending on the piece of environmental information. For example, the control actions include a warning action for the operator issued via a human-machine interface 34 (FIG. 1) and/or a braking action carried out by activating a non-illustrated brake system and/or a steering action carried out by activating a non-illustrated steering system and/or an action to adjust a working unit 3-8 such as raising and/or shutting off the header 4 of a working machine 1 designed as a combine harvester.

The warning action for the operator via the human-machine interface 34 can be, for example, outputting acoustic or optical warning signals or displaying camera images. In this case, it is conceivable that the corresponding warning information, in particular a mention of the detected peripheral object 20, 21, is superimposed on a camera image. The braking action also can be, as indicated above, the activation of a braking system or the triggering of an engine brake. In principle, the braking action can also include a braking instruction for the operator via the human-machine interface 34.

The steering action can include, in principle, an evasive maneuver which is planned and carried out by the driver assistance system 9, in particular, on the basis of GPS navigation data. It also is conceivable, however, that the steering action includes only a steering stop, in order to prevent the operator from creating a collision situation with the detected peripheral object 20, 21. Other control actions are conceivable.

Viewing FIGS. 2 and 3 in combination reveals that control actions, which result depending on the object category and/or the object type and/or the position and/or the movement of the detected peripheral object 20, 21, yield different levels of urgency. For example, in the case of a movement of a living peripheral object 20, 21 in the working area of the working machine 1, the control action of immediate braking with high intensity, i.e., using high braking power, is demanded (FIG. 2). However, if the peripheral object 20, 21 is a rigid object which is located at a safe distance, the urgency of the pending control action, specifically the initiation of an evasive maneuver, is relatively low (FIG. 3).

Correspondingly, it is provided that the driver assistance system 9 assigns an urgency level 35-38 to each of the pieces of environmental information 11-14 and generates the control actions, as explained above, on the basis of the pieces of environmental information 11-14 and the particular assigned urgency levels 35-38. This systemization of the urgency of a piece of environmental information 11-14 makes it possible for the assignment to be easily carried out in an automated manner.

Different advantageous variants for determining the particular urgency level 35-38 are conceivable. In this case and preferably, the driver assistance system 9 derives the particular urgency level 35-38 from the distance of the peripheral object 20, 21 from the working machine 1 and/or from the ground speed of the working machine 1. The direction of motion and/or the speed of the peripheral object 20, 21 also can be incorporated into the determination of the particular urgency level.

Alternatively or additionally, it can be provided that the driver assistance system 9 derives the particular urgency level 35-38 from the determined object category and/or from the determined object type. For example, the determination of a peripheral object 20, 21 in the object category “living” and the object type “human” must always be assigned a high urgency level in order to rule out any risk of injury to a person.

In principle, it also can be provided, however, that a predetermined urgency level is assigned to at least one sensor 15, 22 of the sensor system 10. This is the case, for example, when the particular sensor is a sensor which is mounted directly on the header 4 of a working machine 1 (designed as a combine harvester), and has a small detection zone. For the case in which any type of peripheral object 20, 21 lands in the detection zone of this collision sensor, the relevant piece of environmental information 11-14 must always be assigned a high urgency level.

The driver assistance system 9 implements the control actions based on the pieces of environmental information 11-14 with higher or lower priority than other pending control actions depending on the particular urgency level 35-38. In the case of a control action based on a piece of environmental information having a high urgency level 35-38, a mechanism designed as a type of interrupt can be used, in principle, as has already been indicated further above.

In an embodiment, at least one urgency level 35-38 is assigned to a predetermined control action. For example, the invention may provide precisely three urgency levels 35-38, each of which is assigned to one of the control actions warning action, steering action, and braking action, which will be explained. The unambiguous assignment of urgency levels 35-38 to control actions simplifies the determination of the control actions by the driver assistance system 9. In this case, it must be taken into account that the control actions, in particular the three aforementioned control actions, can each include multiple subactions that triggered depending on the piece of environmental information.

Alternatively, or additionally, the driver assistance system 9 implements the control actions based on the pieces of environmental information 11-14 using different control parameters, in particular, in different intensities, depending on the particular urgency level 35-38. This was already addressed in the context of the braking action.

FIG. 4 shows a preferred mode of operation of the driver assistance system 9. In the lowermost block it is shown that the sensor system 10 generates first pieces of sensor information 16-19 (left) and further pieces of sensor information 23-26 (right) for different situations. The particular associated pieces of sensor information 16, 23; 17, 24; 18, 25; 19, 26 are processed into pieces of environmental information 11-14, which are categorized and typified in an evaluation step 39, as explained above. Subsequently, the pieces of environmental information 11-14 are provided with urgency levels 35-38 in a prioritization step 40, as has also been explained. Finally, the driver assistance system 9 determines, in a planning step 41, the adequate control action 42-44, which, in the overview shown in FIG. 4 by way of example, can be a warning action 42, a steering action 43, or a braking action 44. It is also conceivable in this case to trigger the further control actions mentioned further above.

FIG. 4 shows, in the end, that a differentiated detection of peripheral objects 20, 21 and, furthermore, a differentiated reaction to the detection of peripheral objects 20, 21 is possible, wherein the systemization of the detection using at least two sensors 15, 22 and the assignment of urgency levels results in an automatable process, which ensures a high level of operational reliability and high operating efficiency.

### LIST OF REFERENCE NUMBERS

1 working machine
2 front attachment
3 ground drive
4 header
5 threshing unit
6 separating device
7 cleaning device
8 spreading device
9 driver assistance system
10 sensor system
11, 12, 13, 14 environmental information
15 1^{st} sensor
16, 17, 18, 19 1^{st} piece of sensor information
20, 21 environmental object
22 further sensor
23, 24, 25, 26 further piece of sensor information
27 detection zone
28 direction of travel
29 operator's cab
30 horizontal line
31 center plane
32, 33 object category
34 human-machine interface
35, 36, 37, 38 urgency level
39 evaluation step
40 prioritization step
41 planning step
42, 43, 44 control action

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A self-propelled agricultural working machine, comprising:
at least one working unit;
a ground drive;
a driver assistance system for generating control actions within the working machine;
a sensor system for generating pieces of environmental information;
wherein the driver assistance system assigns an urgency level to each piece of environmental information and generates the control actions on a basis of the pieces of environmental information and on a basis of particular assigned urgency levels.

2. The self-propelled agricultural working machine according to claim 1, wherein the at least one working unit is a ground drive

3. The self-propelled agricultural working machine according to claim 1, wherein the sensor system comprises a first sensor that which gathers a first piece of sensor information on a basis of a first physical property of a peripheral object in the environment of the working machine.

4. The self-propelled agricultural working machine according to claim 3, wherein the sensor system comprises at least one further sensor that gathers a further piece of sensor information on a basis of a further physical property of the peripheral object and wherein the driver assistance system generates, on the basis of the first piece of sensor information and the further piece of sensor information, a piece of environmental information regarding the peripheral object.

5. The self-propelled agricultural working machine according to claim 1, wherein the driver assistance system implements the control actions based on the pieces of environmental information with higher or lower priority than other pending control actions depending on the particular assigned urgency level.

6. The self-propelled agricultural working machine according to claim 1, wherein the driver assistance system assigns an object category from the object categories “living” and “not living” to the peripheral object on a basis of the pieces of environmental information.

7. The self-propelled agricultural working machine according claim 1, wherein the driver assistance system assigns an object type, such as “animal,” “person,” “rigid object” or “vehicle with engine,” to the peripheral object on a basis of the generated pieces of environmental information.

8. The self-propelled agricultural working machine according to claim 1, wherein the driver assistance system makes the assignment of the object category an object type dependent on whether a first necessary condition relating to the first piece of sensor information and a second necessary condition relating to the further piece of sensor information, or both have been met.

9. The self-propelled agricultural working machine according to claim 8, wherein the object type dependent on whether a first necessary condition relating to the first piece of sensor information is a predetermined shape.

10. The self-propelled agricultural working machine according to claim 8, wherein the second necessary condition relating to the further piece of sensor information is a predetermined temperature range.

11. The self-propelled agricultural working machine according to claim 1, wherein the control actions generated by the driver assistance system on a basis of the pieces of environmental information include a warning action for the operator issued via any of the following: a human-machine interface, a braking carried out by activating a brake system, a steering action carried out by activating a steering system and an action to adjust a working unit.

12. The self-propelled agricultural working machine according to claim 1, wherein at least one urgency level is assigned to a predetermined control action.

13. The self-propelled agricultural working machine according to claim 1, wherein the driver assistance system derives the urgency level from the distance of the peripheral object from the working machine, from a ground speed of the working machine or both.

14. The self-propelled agricultural working machine according to claim 1, wherein in that the driver assistance system derives the urgency level from an object category, and object type or both.

15. The self-propelled agricultural working machine according claim 1, wherein a predetermined urgency level is assigned to at least one sensor of the sensor system.

16. The self-propelled agricultural working machine according to claim 1, wherein the driver assistance system implements the control actions based on the pieces of environmental information using different control parameters depending on the particular urgency level.
